(19) United States
(12) Patent Application Publication
(10) Pub. No.: US 2014/0081508 A1
(43) Pub. Date: Mar. 20, 2014

(54) Automotive Control Unit and Automotive Control System

(71) Applicant: Hitachi Automotive Systems, Ltd., Hitachinaka-shi (JP)

(72) Inventors: Takahiro IIDA, Atsugi (JP); Fumio NARISAWA, Hitachinaka (JP); Toshifumi YOSHIKAWA, Hitachinaka (JP); Masahiro MATSUBARA, Tokai (JP); Tohma YAMAGUCHI, Kawasaki (JP)

(73) Assignee: Hitachi Automotive Systems, Ltd., Hitachinaka-shi (JP)

(21) Appl. No.: 13/972,570

(22) Filed: Aug. 21, 2013

(30) Foreign Application Priority Data
Sep. 18, 2012 (JP) 2012-203842

(51) Int. Cl. B60W 50/02

(52) U.S. Cl. CPC B60W 50/0205
USPC 701/29.2

(57) ABSTRACT

An object of the present invention is to enhance the accuracy and the level of detail of an abnormality diagnosis by checking a transmitting-end application or controller for an abnormality by using abnormality diagnosis results concerning a plurality of communication messages. Disclosed is an automotive control unit having a plurality of applications for controlling a vehicle-mounted device and a common execution environment section for permitting the applications to exchange data with each other. The automotive control unit includes a communication protection section that, when the applications exchange data with the common execution environment section, checks the data for an abnormality, and a system abnormality check section that determines in accordance with an abnormality check result produced by the communication protection section whether the system is abnormal.

### BACKGROUND OF THE INVENTION

1. Field of the Invention

The present invention relates to an automotive control unit for controlling a vehicle-mounted device.

2. Description of the Related Art

Conventionally, a vehicle-mounted control unit having a communication network checks for an abnormality in a communication message received from the outside and performs processing in accordance with the result of the check. A function disclosed, for instance, in JP-1996-9471-A checks for an abnormality in all communication messages in a control logic section of a communication processing section implemented by a communication control circuit, and stops communication if a communication message is abnormal.

A certain software configuration for a vehicle-mounted control unit includes an infrastructure software section and a common execution environment section. The infrastructure software section includes applications operative as a calculation section for exercising individual functions to control a vehicle-mounted device and a function commonly used between different applications, and offers a predefined interface to the applications. The common execution environment section is positioned between the applications and the infrastructure software section to offer a data exchange environment for the applications while the infrastructure software section is hidden from the applications. When the common execution environment is provided, the influence of changes in the applications upon the other portions can be localized. This makes the applications highly portable, thereby contributing toward productivity improvement. For example, AUTOSAR (AUTomotive Open System ARchitecture, http://www.autosar.org/), which is a vehicle-mounted software standard, prepares a common execution environment called “RTE (Run Time Environment)” in software, implements a calculation section for exercising electronic control as a software component, and operates the calculation section in RTE.

Further, it is demanded in recent years that a functional safety standard be complied with in order to assure the safety of an electronic control system. To ensure that a communication function complies with the functional safety standard, it is essential that communication data be protected and inspected between data exchange applications to enhance the reliability of the communication data. Hence, in order to ensure that software having the common execution environment complies with the functional safety standard, it is necessary to check each message for an abnormality on an individual application basis.

### SUMMARY OF THE INVENTION

A technology described in JP-1996-9471-A is such that a communication message is checked for an abnormality by using a communication processing section that performs a data transmission/reception process with respect to a communication network. Therefore, a transmitting end can be checked for an abnormality through the communication network in accordance with abnormality diagnosis results concerning a plurality of communication messages. In a software configuration having the common execution environment described in http://www.autosar.org/, however, no particular attention is paid to communication data protection between applications. Further, even if an abnormality check function for checking individual communication messages as described in JP-1996-9471-A is distributively arranged in a simple manner in each application in the common execution environment, an abnormality check cannot be performed on an individual system basis or on an individual control unit basis by using abnormality check results concerning a plurality of communication messages.

Moreover, even if each application is provided with an abnormality check function that checks each communication message, the operation of each application may affect an abnormality check process to erroneously check the transmitting end for an abnormality.

The present invention has been made in view of the above circumstances. An object of the present invention is to enhance the accuracy and the level of detail of an abnormality diagnosis by checking a transmitting-end application or controller for an abnormality by using abnormality diagnosis results concerning a plurality of communication messages.

To achieve the above object, the present invention implements, on an application level, a software component having a function of collecting communication abnormality check results and a function of checking each system for an abnormality. Therefore, even if an employed configuration is such that messages are checked for a communication abnormality on an individual application basis, the present invention collects communication abnormality check results to determine whether the system is abnormal.

Further, the present invention changes a check rule by using the operating status of an application.

In a software configuration having a common execution environment, the present invention can protect communication messages between individual applications and check each system for an abnormality by using abnormality check results concerning a plurality of communication messages.

Further, as the present invention changes the check rule by using the operating status of an application, the present invention properly performs the abnormality checks by using the abnormality check results concerning the communication messages even if an abnormality check process on each communication message is affected by the operating status of each application.

### BRIEF DESCRIPTION OF THE DRAWINGS

FIG. 1 is a diagram illustrating a vehicle-mounted control system to which the present invention is applied.

FIG. 2A is a diagram illustrating the software configuration of the present invention.

FIG. 2B is a diagram illustrating the configuration of a system status determination section.

FIG. 3A is a diagram illustrating a communication message.

FIG. 3B is a diagram illustrating the relationship between notification parameters and application operating states.

FIG. 4 is a flowchart illustrating a process performed by a transmitting-end communication abnormality check section (communication protection section).

FIG. 5 is a flowchart illustrating a process performed by a receiving-end communication abnormality check section (communication protection section).

FIG. 6 is a flowchart illustrating a communication abnormality check method.

FIG. 7A is a flowchart illustrating a process performed by an application operating status management section.

FIG. 7B shows an operating status table.

FIG. 8A is a flowchart illustrating a process performed by a check rule decision section.

FIG. 8B shows a check rule selection table.

FIG. 9A is a flowchart illustrating a process performed by a status determination section.

FIG. 9B shows a check table that is used when an application is in an ordinary state.

FIG. 9C shows a check table that is used when an application is partially halted.

FIG. 10 is a diagram illustrating a materialized application.

FIG. 11A is a diagram illustrating communications between ECUs.

FIG. 11B shows a check table of a diagnostic application.

FIG. 12A is a diagram illustrating communications that are held between ECUs when a regeneration application is halted.

FIG. 12B shows a check table that is used after a diagnostic application change.

### DESCRIPTION OF THE PREFERRED EMBODIMENT

An embodiment of the present invention will now be described with reference to the accompanying drawings.

### First Embodiment

A basic configuration of the present invention is described below.

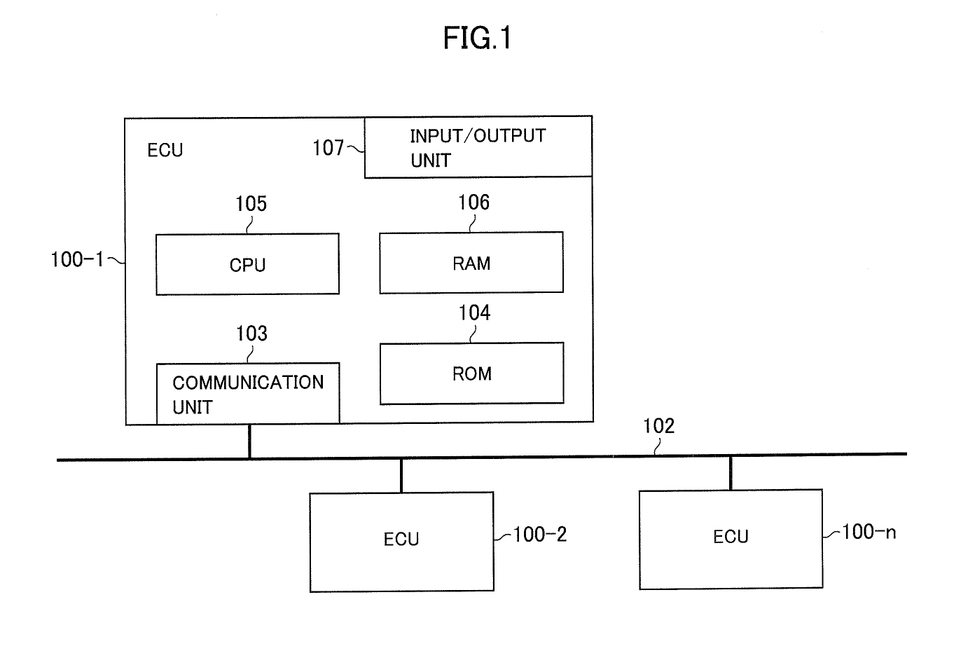

FIG. 1 shows a vehicle-mounted control system to which the present invention is applied. The vehicle-mounted control system includes at least two ECUs (Electronic Control Units) 101-1, 101-2, . . . , 101-n, which are connected to a communication network 102 to mutually exchange data. The ECUs 100 each include a communication unit 103, a ROM (Read Only Memory) 104, a CPU (Central Processing Unit) 105, a RAM (Random Access Memory) 106, and an input/output unit 107. The communication unit 103 receives data from the communication network 102 or transmits data to the communication network 102. The ROM 104 is a storage unit that stores a program. The CPU 105 is an arithmetic circuit that executes the program stored in the ROM 104. The RAM 106 is a storage unit that memorizes the status of software. The input/output unit 107 acquires a value from a sensor and outputs a control signal to an actuator to be controlled.

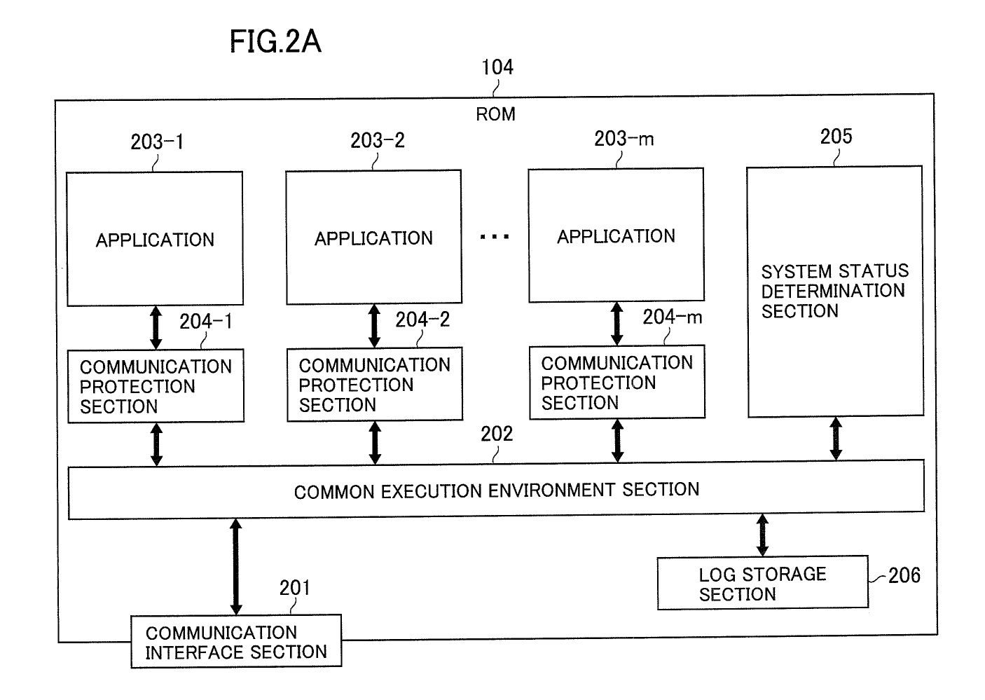

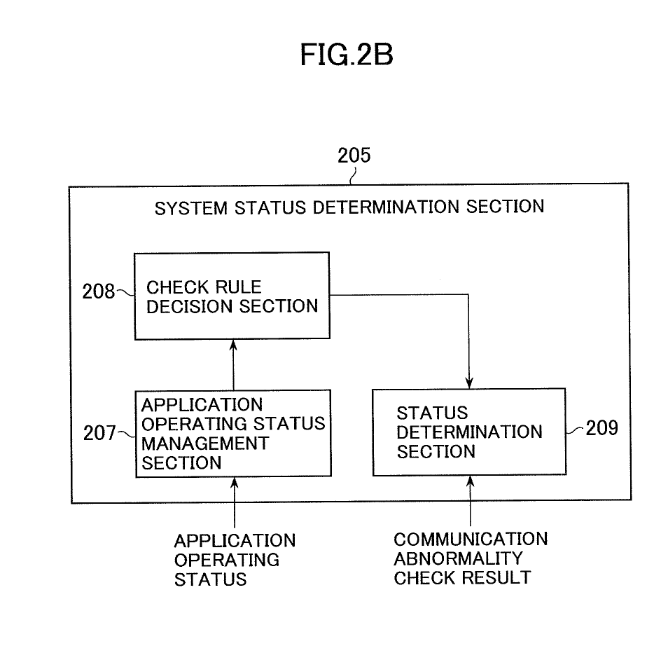

FIGS. 2A and 2B show the software configuration of the present invention. FIG. 2A shows an overall software configuration. The contents of FIG. 2A are stored in the ROM 104 of each ECU 100 and executed by the CPU 105. The status of software is temporarily stored in the RAM 106.

A communication interface section 201 has a function of transmitting a communication message to and receiving a communication message from the communication network 102 and a function of attaching destination information to communication data in the communication network 102 and converting the communication data to a data format (e.g., a bit-string expression) in the communication network 102.

A common execution environment section 202 has a function of managing and executing data communications between applications 203 and a function of starting a certain process of the applications 203 no matter whether they belong to the local ECU 100 or to a remote ECU 100, provides the applications with an interface for data exchanges, and manages the data communications of the applications 203.

The applications 203-1, 203-2, . . . , 203-m have a function of performing various calculations to control an automobile and its controller, perform a diagnostic check process, and exercise input/output management. The configuration according to the present invention includes at least one application 203.

A communication protection section 204 is positioned between an application 203 and the common execution environment section 202, has a function of attaching protection data to the data to be delivered from the application 203 to the common execution environment section 202, and has a function of checking for an abnormality in the data to be delivered from the common execution environment section 202 to the application 203.

A system status determination section 205 (system abnormality check section) collects protection data abnormality check results produced by the communication protection section 204 and the operating status of the application 203, and checks for an abnormality in an application at a message transmitting end or an abnormality in the controller.

A log storage section 206 can store communication protection results produced by the communication protection section 204 and system status determination results produced by the system status determination section 205. Data that can be stored in the log storage section 206 is not limited to the communication protection results and system status determination results.

FIG. 2B shows the functions of the system status determination section 205. An application operating status management section 207 acquires application operating status data, which is transmitted from each application, from the common execution environment section 202, arranges the acquired data in the form of an operating status table, and conveys the operating status table to a check rule decision section 208. The check rule decision section 208 selects a check rule for use in a status determination section 209 by using the data on the operating status of each application, which is delivered from the application operating status management section 207, and notifies the status determination section 209 of the selected check rule. The status determination section 209 receives one or more communication abnormality check results, which are transmitted from the communication protection section 204, from the common execution environment section 202, and determines the status of a transmitting-end application or controller by using the communication abnormality check results.

In the present invention, at least one communication protection section is necessary for a transmitting end and for a receiving end. However, the communication protection section need not always be provided for all applications.

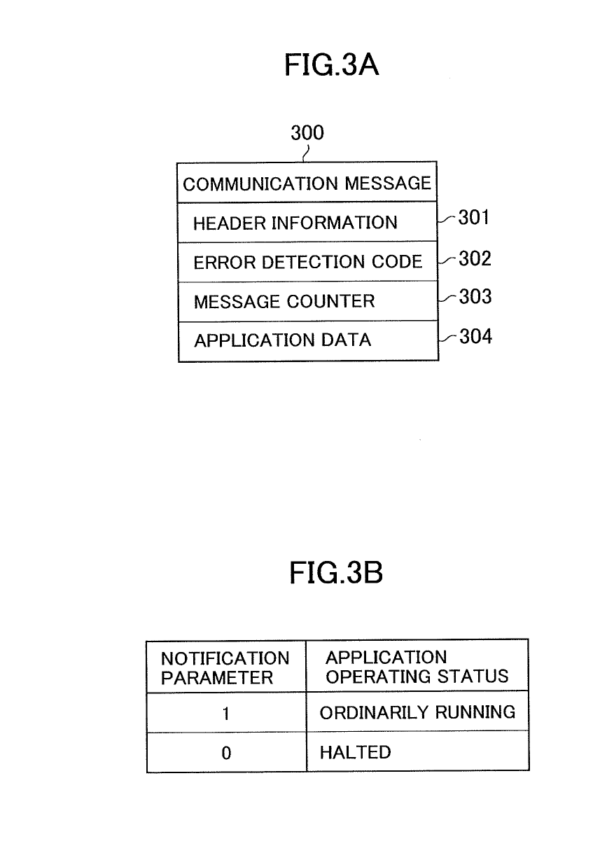

FIGS. 3A and 3B show a communication message that flows in the common execution environment section 202. FIG. 3A shows data included in the communication message. The communication message includes header information 301, application data 304 generated by an application 203 and transmitted to a destination, and protection data calculated by the communication protection section 204. The header information 301 includes, for instance, destination information. The protection data includes an error detection code 302 and a message counter 303. The error detection code 302 is calculated from a bit string of the application data 304 and detectable when a value having one or more bits is inverted. The message counter 303 identifies the order of messages.

For example, an 8-bit CRC is used as the error detection code 302. The 8-bit CRC is an error detection code that works in an 8-bit data region. The error detection code 302 is not limited to the 8-bit CRC. A different error detection code, such as a CRC having a different number of bits or a checksum, may be used as the error detection code 302.

The message counter 303 is expressed, for instance, by 4 bits (a counter that cycles between 0 and 15). The communication protection section retains the latest message counter value for each message and increments the value of the counter correctly. The message counter 303 is not limited to a 4-bit value.

The application data 304 includes a piece of data, which is the data concerning the operating status of an application. The current operating status of an application is expressed by a numerical value. The system status determination section is notified of this numerical value when the operating status of an application is changed or at predetermined time intervals. FIG. 3B is a data table that shows numerical values indicative of the operating status of an application. A communication parameter value of 1 indicates that the application is ordinarily running. A communication parameter value of 0 indicates that the application is halted. The present invention requires two or more operating states. However, each application may have three or more operating states. The application data 304 is not limited to the above, but is data other than the header information 301 and the protection data such as the error detection code 302 and the message counter 303.

The communication message is not allowed to exceed 8 bytes in data length if, for example, CAN, which is one of on-board communication protocols, is used. The size of a message and the protocol and data format to be used are not limited to the above. However, a predetermined maximum data length must not be exceeded.

The system configuration according to the present invention has been described above. A basic behavior of the system to which the present invention is applied will now be described.

A software process performed by a transmitting-end ECU 100-x (x=1 to n) is described below.

In a process performed by a transmitting-end ECU, the application data 304 to be transmitted by an application 203 is prepared. The communication protection section 204 then attaches protection data to the application data 304. The application data to which the protection data is attached passes through the common execution environment section 202. The communication interface section 201 then attaches the header information 301 to the application data. A communication message is eventually transmitted to the communication network 102.

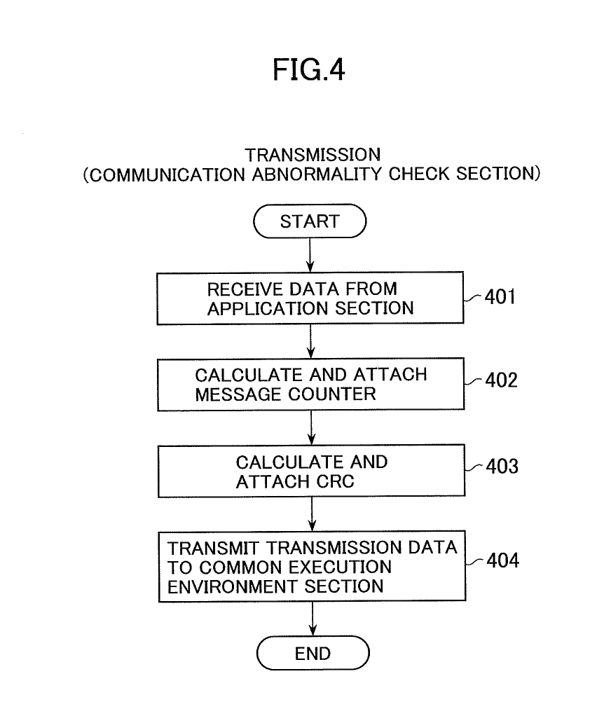

FIG. 4 is a flowchart illustrating a transmission process performed by the communication protection section 204.

First of all, in step 401, the communication protection section 204 receives, from an application, transmission data with a transmission request and data containing destination application information.

Next, in step 402, a previous value retained by the message counter 303 is incremented by one, and the resulting value is calculated as the next value of the message counter 303. The calculated value of the message counter 303 and the application data 304 are both stored in a communication message.

Next, in step 403, an 8-bit CRC is calculated as the error detection code 302 for the communication message in which the application data 304 and the message counter 303 are stored, and the value of the 8-bit CRC is stored in the communication message.

Next, in step 404, data is transmitted by delivering the communication message and the destination application information to the common execution environment section 202.

Upon receipt of the communication message and the destination application information, the common execution environment section 202 attaches destination ECU information to the data in accordance with table information that is set on the basis of the destination application information included in the communication message, and transmits the data to the communication interface section 201. The communication interface section 201 transmits the data to the communication network 102.

A reception process performed by the software of a receiving-end ECU 100-X (X=1 to n) is described below.

The communication interface section 201 of the receiving-end ECU 100-X (X=1 to n) receives the data and delivers the received data to the common execution environment section 202. The common execution environment section 202 passes the received data to one of the communication protection sections 204-1 to 204-m on the bases of the destination application information.

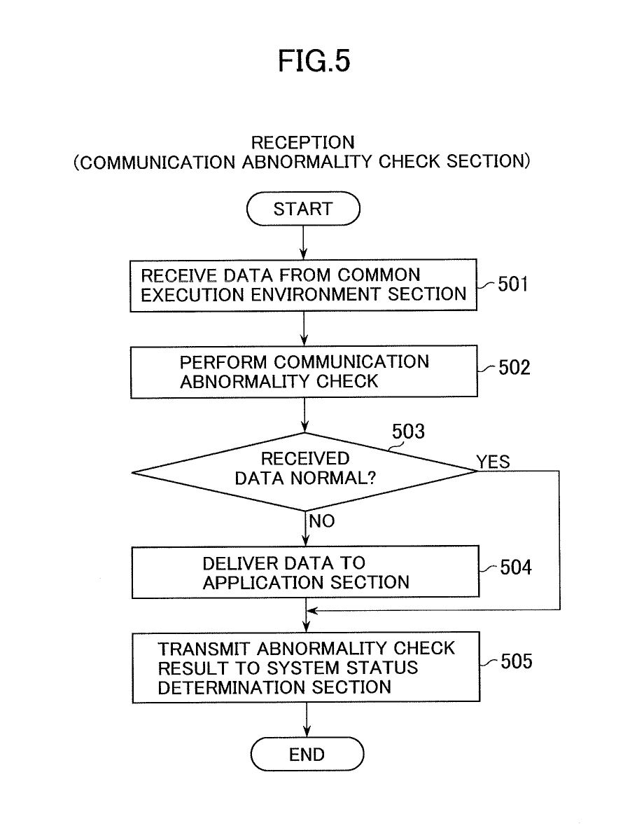

FIG. 5 is a flowchart illustrating a reception process performed by the communication protection section 204. First of all, in step 501, the communication message addressed to the communication protection section 204 is received from the common execution environment section 202.

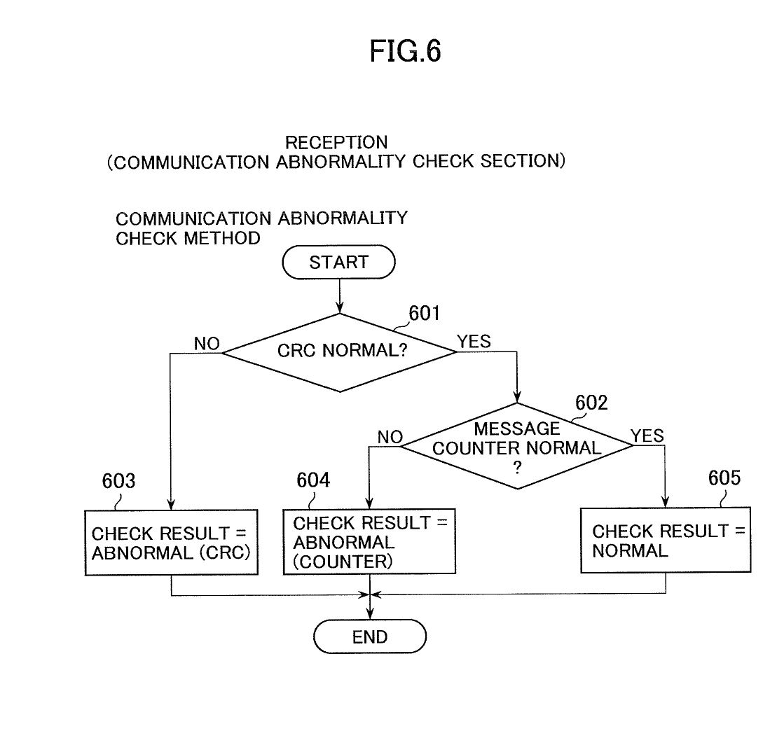

Next, in step 502, the data attached to the communication message 401 is examined to check for an abnormality. The method and process of the abnormality check will be described later with reference to FIG. 6.

Next, step 503 is performed to determine whether the data examined in step 502 is normal. If the examined data is normal, processing proceeds to step 505. If, on the other hand, the examined data is abnormal, processing proceeds to step 504.

Next, in step 504, the communication data, which is found to be normal, is delivered to the application.

Next, in step 505, the result of the abnormality check is delivered to the common execution environment section with the system status determination section 205 set as the destination in order to deliver the abnormality check result to the system status determination section 205.

FIG. 6 is a flowchart illustrating a communication abnormality check method exercised in step 502.

First of all, in step 601, the CRC or other error detection code stored in the communication message is compared to a value calculated from a message region irrelevant to the error detection code. If the compared items are equal, the data is determined to be normal and processing proceeds to step 602. If, on the other hand, the compared items are not equal, the data is determined to be abnormal and processing proceeds to step 603.

Next, step 602 is performed to determine whether the message counter is abnormal. The message counter is checked for an abnormality by comparing its current value to its previous value stored in the receiving-end communication protection section. If the current value is equal to the previous value or a wrong sequence is stored in the counter, the message counter is determined to be abnormal and processing proceeds to step 604. If the message counter is normal, processing proceeds to step 605.

In step 603, the check result is determined to be abnormal as the error correction code is abnormal.

In step 604, the check result is determined to be abnormal as the message counter is abnormal.

In step 605, the check result is determined to be normal as no abnormality is found.

The abnormality check method and check result are not limited to the above. Any abnormality check method and check result may be used as far as the system status determination section is notified of the check result of each communication message. For example, the error detection with the CRC or the like and the abnormality check with the message counter may be performed separately.

A software operation performed by a receiving-end ECU (generically designated by reference numeral 100) will now be described.

The application 203-M (M=1 to m) notifies the system status determination section 205 of its operating status. The application 203-M handles its operating status as the application data 304 and delivers the application data 304 to the common execution environment section 202 with the system status determination section 205 set as a destination application. In accordance with the destination application information, the common execution environment section 202 delivers the received data to the system status determination section 205.

The communication protection section 204-M (M=1 to m) notifies the system status determination section 205 of an abnormality check result through the common execution environment section 202 no matter whether the abnormality check result indicates normality or abnormality. The abnormality check result is handled as the application data 304 and delivered to the common execution environment section 202 with the system status determination section 205 set as a destination application. In accordance with the destination application information, the common execution environment section 202 delivers the received data to the system status determination section 205.

In the system status determination section 205, the application operating status management section 207 collects and manages the status data about the application 203-M (M=1 to m), and notifies the check rule decision section 208 of the operating status of the application.

In accordance with the operating status of the application, the check rule decision section 208 determines the check rule to be used by the status determination section 209 and conveys the information about the check rule to the status determination section 209.

In accordance with the abnormality check result produced by the communication protection section 204-M and with the check rule conveyed from the check rule decision section 208, the status determination section 209 determines the status of a transmitting-end application or controller.

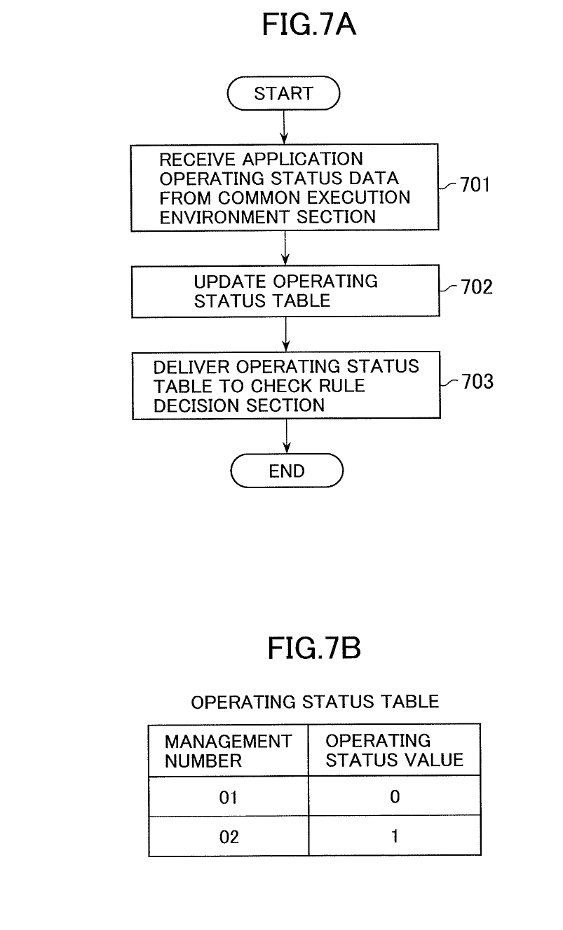

FIGS. 7A and 7B illustrate a process performed by the application operating status management section 207.

FIG. 7A is a flowchart illustrating the process performed by the application operating status management section 207. FIG. 7B shows the operating status table that records the operating status of each application and is handled by the application operating status management section 207.

The process performed by the application operating status management section 207 is described below with reference to FIG. 7A.

First of all, in step 701, a reception process is performed to receive the operating status data about each application from the common execution environment section 202.

Next, in step 702, the received operating status data about each application is stored in the operating status table. As shown in FIG. 7B, the operating status table includes a region that stores a management number unique to each application 203 and an operating status value of each application. In step 702, the value of the operating status data is stored in the operating status value field of an associated application.

Next, in step 703, the operating status table is passed to the check rule decision section 208.

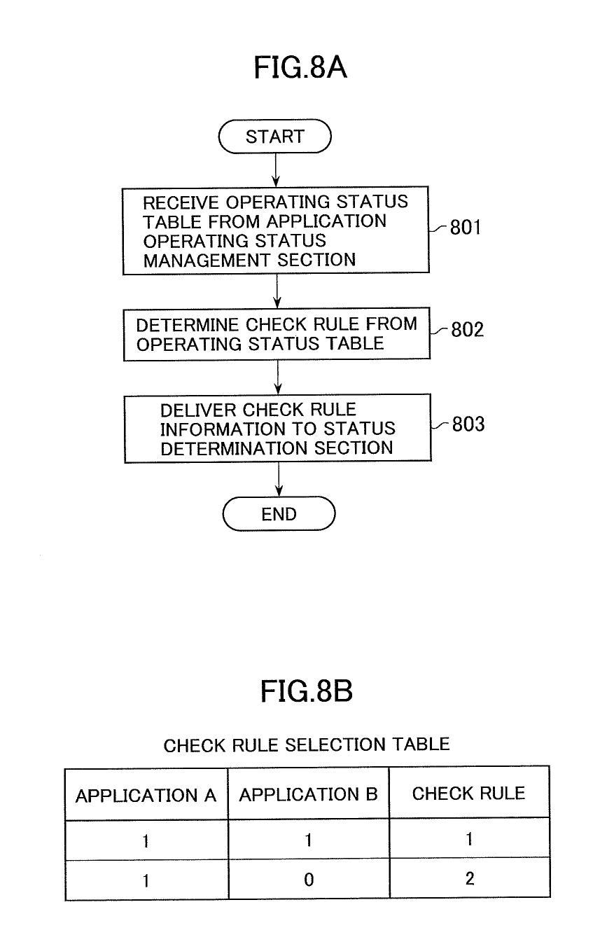

FIGS. 8A and 8B illustrate a process performed by the check rule decision section 208. FIG. 8A is a flowchart illustrating the process performed by the check rule decision section 208. FIG. 8B shows a check rule selection table that is used to determine the check rule.

The process performed by the check rule decision section is described below with reference to FIG. 8A.

First of all, in step 801, an operating status management table is received from the application operating status management section 207.

Next, in step 802, the check rule appropriate for the current application situation is determined in accordance with the information in the operating status management table and with the information in the check rule selection table. As shown in FIG. 8B, the check rule selection table is used to select an appropriate check rule in accordance with the operating status combination of the applications.

Next, in step 803, the information about the check rule determined in step 802 is passed to the status determination section 209.

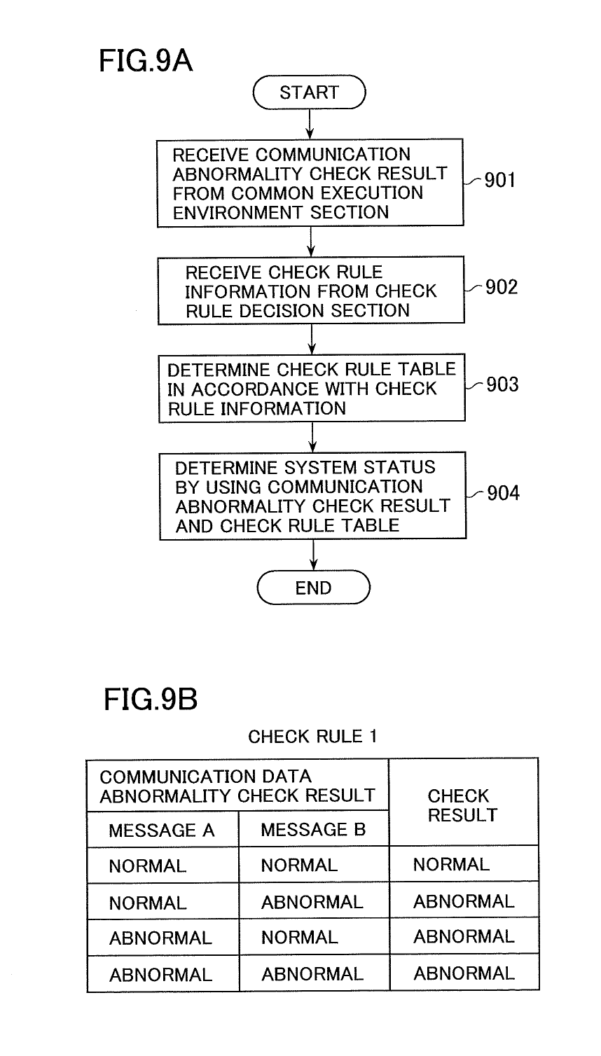

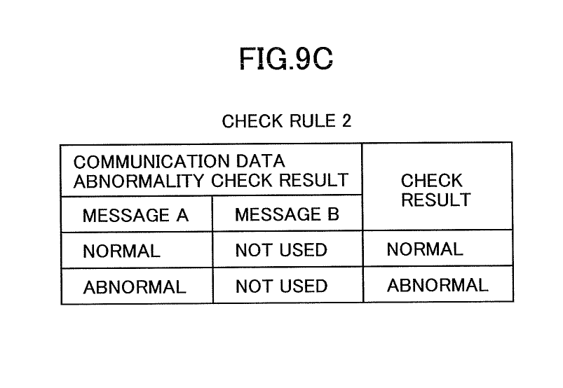

FIGS. 9A, 9B, and 9C illustrate a process performed by the status determination section 209.

FIG. 9A is a flowchart illustrating the process performed by the status determination section 209. FIGS. 9B and 9C illustrate a check rule table that is used by the status determination section 209.

The process performed by the check rule decision section is described below with reference to FIG. 9A.

First of all, in step 901, a reception process is performed to receive the abnormality check result concerning each message from the common execution environment section 202.

Next, in step 902, check rule information is received from the check rule decision section 208.

Next, in step 903, the check rule table is determined from the check rule information. As shown in FIGS. 9B and 9C, the check rule table is used to derive a status check result from the combination of the abnormality check results concerning messages. FIG. 9B shows a check rule that is used when each application is in an ordinary state as shown in FIG. 8B and applicable to various abnormality check result combinations of messages A and B. FIG. 9C shows a check table that is used when application B is halted as shown in FIG. 8B and indicates that a check result is derived from the abnormality check result concerning message A only.

Next, in step 904, the system status is determined in accordance with the check table determined in step 903 and with the communication abnormality check result received in step 901.

The status determination result produced by the system status determination section can be used to prepare a signal that is transmitted in the event of an abnormality to a warning lamp or other external device for notifying an automobile driver or maintenance personnel of the abnormality through the input/output unit 107. Further, the status determination result can be stored in the log storage section 206 and used to investigate a failure. The use of the status determination result is not limited to the above. The status determination result may be used in various ways.

When the above configuration is used, even the software compliant with AUTOSAR, functional safety standard can make a diagnosis on an individual application/controller basis by using communication abnormality check results. Further, the use of application operating status makes it possible to make a diagnosis without producing an incorrect check result.

The general configuration and behavior of the vehicle-mounted control unit to which the present invention is applied have been described above.

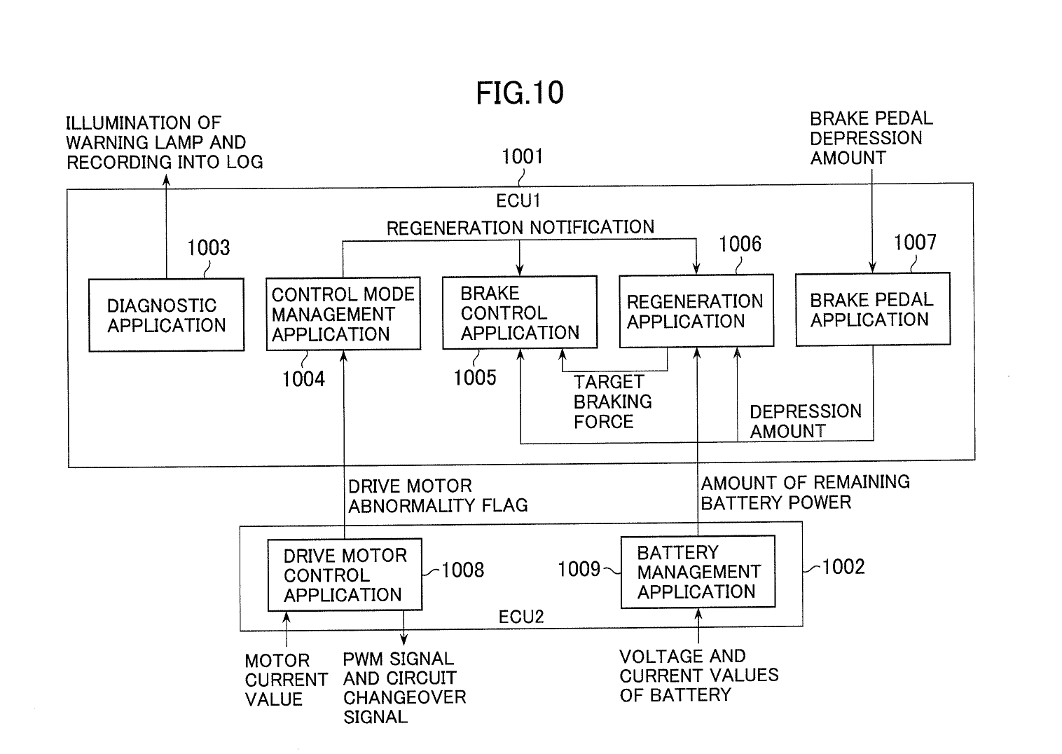

FIG. 10 shows the application 203 materialized as an embodiment of the vehicle-mounted control system to which the present invention is applied. FIG. 10 shows the flow of data between the applications of two ECUs. For the sake of simplicity, the communication protection section 204 is omitted from the figure as it is considered to be included in the application 203.

An ECU 1001 corresponds to the ECU 100 that is shown, for instance, in FIG. 1 and has a function of causing software to perform calculations for brake control. The ECU 1001 has a warning lamp as an external output means and includes a storage section capable of storing an abnormality log.

An ECU 1002 corresponds to the ECU 100 according to the present invention and has a function of causing the software to perform calculations for motor control and exercise battery management.

A diagnostic application 1003 corresponds to the system status determination section 205 shown in FIGS. 2A and 2B and is included in the ECU 1001. The diagnostic application 1003 collects information about operating modes of applications in the ECU 1001 and abnormality check results, illuminates the warning lamp, and stores a log in the storage section.

A control mode management application 1004 functions as the application operating status management section 207 of the system status determination section 205, has the communication protection section 204, and is included in the ECU 1001. In accordance with the ON/OFF state of a drive motor abnormality flag from the ECU 1002, the control mode management application 1004 transmits regeneration data to a brake control application 1005 and a regeneration application 1006 in the ECU 1001. The regeneration data specifies whether or not to apply a regenerative brake.

The brake control application 1005 corresponds to the application 203, has the communication protection section 204, and is included in the ECU 1001. The brake control application 1005 has a function of acquiring stroke sensor data about a brake pedal, subjecting the acquired data to analog-to-digital conversion, and using the resulting data as brake pedal depression amount data. If the regeneration data from the control mode management application 1004 specifies the execution of regeneration, the brake control application 1005 calculates the braking force of a brake in accordance with the brake pedal depression amount indicated by a brake pedal application 1007 and with a target braking force indicated by the regeneration application 1006. If, on the other hand, the regeneration data from the control mode management application 1004 does not specify the execution of regeneration, the brake control application 1005 calculates the braking force of the brake in accordance with the brake pedal depression amount indicated by the brake pedal application 1007, and controls the brake accordingly.

The regeneration application 1006 corresponds to the application 203, has the communication protection section 204, and is included in the ECU 1001. The regeneration application 1006 has a function of calculating the braking force of the regenerative brake, which uses rotational resistance exhibited when a motor is used as a generator. In accordance with the brake pedal depression amount indicated by the brake pedal application 1007, the regeneration application 1006 notifies the brake control application 1005 of a target braking force that is to be applied when the regenerative brake is used additionally. Further, if the regeneration data from the control mode management application 1004 does not specify the execution of regeneration, the regeneration application 1006 halts its operation until the regeneration data specifies the execution of regeneration.

The brake pedal application 1007 corresponds to the application 203, has the communication protection section 204, and is included in the ECU 1001. The brake pedal application 1007 acquires the brake pedal depression amount of the brake pedal manipulated by a driver and reports the brake pedal depression amount to the regeneration application 1006 and the brake control application 1005.

A drive motor control application 1008 corresponds to the application 203, has the communication protection section 204, and is included in the ECU 1002. The drive motor control application 1008 measures the present electrical current value of the motor, calculates the driving force of the motor from the measured electrical current value, and outputs the calculated driving force to the motor as a PWM signal. Further, the drive motor control application 1008 checks the electrical current value to determine whether the motor is being driven normally. If any abnormality is encountered, the drive motor control application 1008 reports it to the control mode management application 1004 in the ECU 1001.

A battery management application 1009 corresponds to the application 203, has the communication protection section 204, and is included in the ECU 1002. The battery management application 1009 calculates the amount of remaining battery power from the voltage and current values of a battery and reports the calculated amount to the regeneration application 1006 in the ECU 1001.

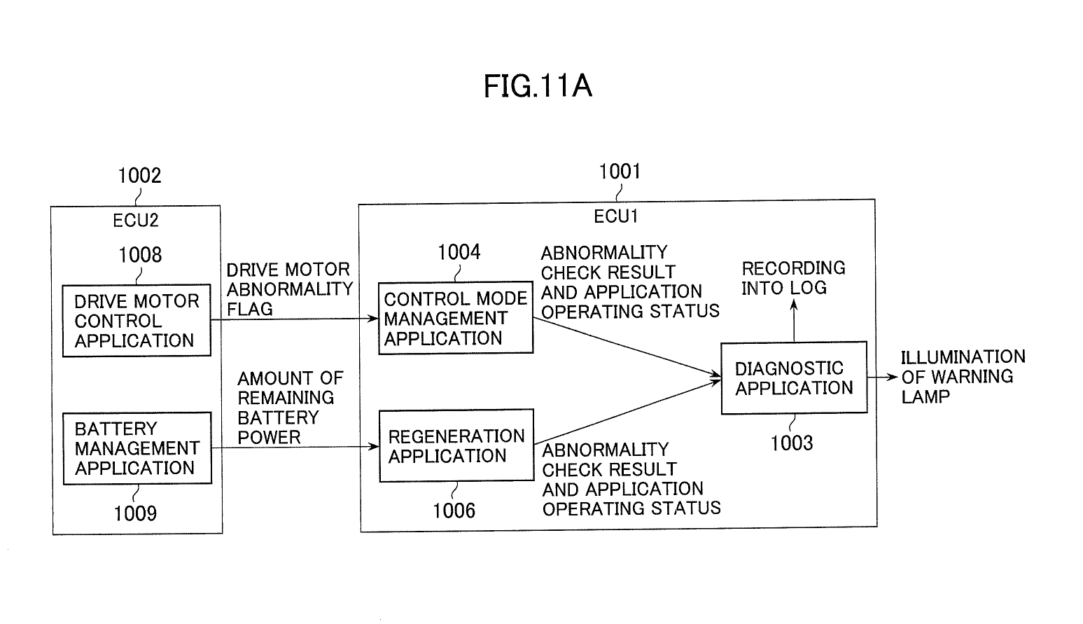

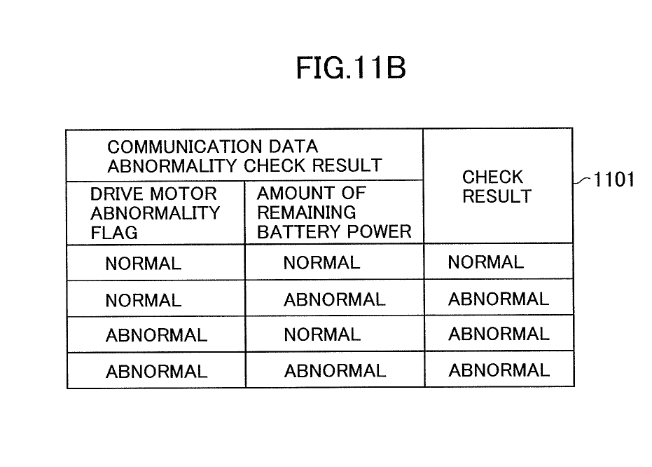

A process performed by the diagnostic application 1003 in the ECU 1001 to determine the status of the ECU 1002 will now be described with reference to FIGS. 11A and 11B. FIG. 11A shows data communications between the ECU 1002 and the ECU 1001, which are shown in FIG. 10.

Communication data about the drive motor abnormality flag transmitted from the drive motor control application 1008 is checked for an abnormality by an abnormality check section 204 of the control mode management application 1004. The result of the abnormality check is conveyed to the diagnostic application 1003.

Communication data about the amount of remaining battery power, which is transmitted from the battery management application 1009, is checked for an abnormality by the communication protection section 204 of the regeneration application 1006. The result of the abnormality check is conveyed to the diagnostic application 1003.

The diagnostic application 1003 determines the operating status of the ECU 1002 from the result of the abnormality check. If it is determined that the ECU 1002 is abnormal, the diagnostic application 1003 performs a process of illuminating the warning lamp. The result of system status determination is stored in the log storage section 206 as a log. If necessary, in addition to warning lamp illumination, the diagnostic application 1003 may perform a fail-safe process and exercise vehicle-mounted device control in accordance with an encountered abnormality.

FIG. 11B shows a data table indicative of a check rule that is observed when the diagnostic application 1003 determines the system status. The operating status of the ECU 1002 is determined from the abnormality check result combination of two sets of transmission data.

When the above-described configuration is employed, the regeneration application 1006 may come to a halt due to its communication with the control mode management application 1004. In this instance, the diagnostic application 1003 cannot properly determine the status because it cannot acquire the abnormality check result concerning the communication data about the amount of remaining battery power, which is one of various sets of transmission data used for an abnormality check. When, for instance, the regeneration application 1006 is halted, it is conceivable that the battery management application 1009 may be erroneously determined to be abnormal. Further, if the drive motor control application 1008 is abnormal and the regeneration application 1006 is halted in a situation where the ECU 1002 is found to be completely abnormal due to an abnormality indicated by both the communication data about the drive motor abnormality flag and the communication data about the amount of remaining battery power, it is impossible to determine whether only the drive motor control application 1008 is abnormal or whether the ECU 1002 is completely abnormal.

Hence, upon receipt of the drive motor abnormality flag from the drive motor control application 1008, the control mode management application 1004 transmits a regeneration notification to the brake control application 1005 and the regeneration application 1006 so as to specify that regeneration is not to be executed.

Upon receipt of the regeneration notification indicative of no regeneration, the regeneration application 1006 changes its operating status from normal to halted. When the operating status is changed to halted, the regeneration application 1006 conveys application operating status information to the diagnostic application 1003 to indicate that the regeneration application 1006 has come to a halt.

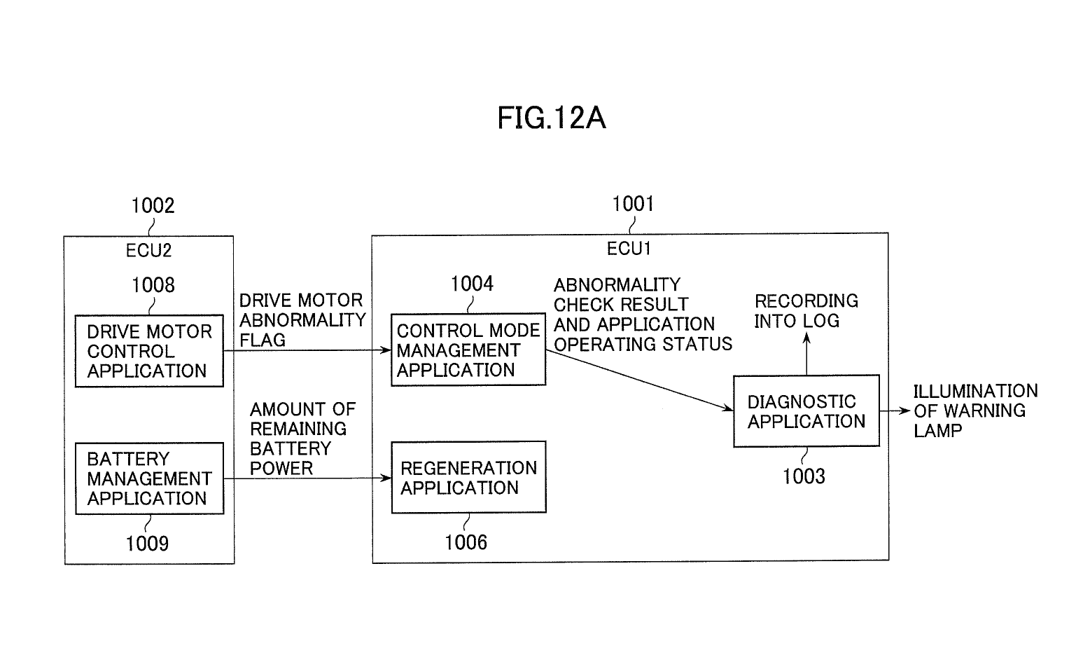

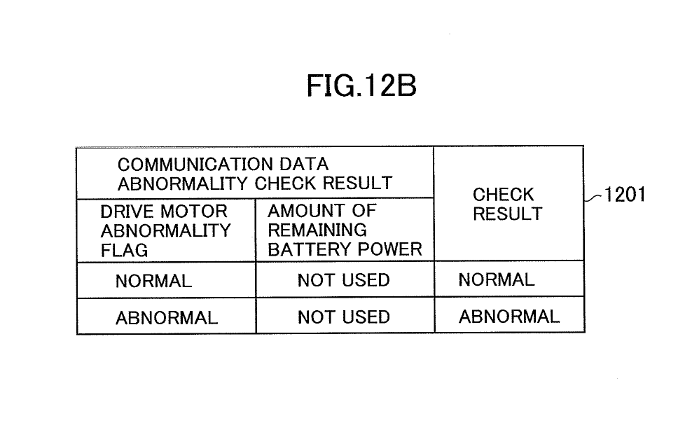

Upon receipt of the application operating status information indicating that the regeneration application 1006 has come to a halt, the diagnostic application 1003 updates an application operating status table (equivalent to the table shown in FIG. 7B) by its function corresponding to the function of the application operating status management section 207. Further, the diagnostic application 1003 exercises its function corresponding to the function of the check rule decision section 208 to change the check rule from the one indicated at 1101 in FIG. 11B to the one indicated at 1201 in FIG. 12B in accordance with its operating status. This enables the diagnostic application 1003 to properly continue with the status check even when the regeneration application 1006 is halted.

If, on the contrary, the diagnostic application 1003 receives the application operating status information indicating that the regeneration application 1006 has recovered from a halt state, the diagnostic application 1003 should change the check rule from the one indicated at 1201 in FIG. 12B to the one indicated at 1101 in FIG. 11B in accordance with its operating status.

A method of determining the operating status of the ECU 1002 when the regeneration application 1006 has halted will now be described with reference to FIGS. 12A and 12B. Referring to FIG. 12A, as the regeneration application 1006 has halted, the battery management application 1009 does not perform a process of receiving the amount of remaining communication data battery power or a process of checking for a communication abnormality. Hence, the abnormality check result produced by the control mode management application 1004 is transmitted to the diagnostic application 1003.

Referring to FIG. 12B, a changeover is made in accordance with the reported status of the regeneration application 1006 to an abnormality check table 1201 that does not use the communication abnormality check function of the regeneration application 1006. Therefore, the status of the ECU 1002 is determined only in accordance with a communication abnormality check result indicated by the drive motor abnormality flag.

The above configuration makes it possible to perform a diagnostic check on each application and on each controller by using communication abnormality check results even when the employed software is such that applications individually operate in the common execution environment section. If, for instance, only some communication messages are found abnormal in a situation where one controller transmits a plurality of communication messages, it can be determined that the transmitting-end controller is partially abnormal due, for instance, to abnormalities in some applications. If, on the other hand, all communication messages are found abnormal, it can be determined that the transmitting-end controller is completely abnormal.

Further, a diagnosis can be made without producing an incorrect diagnostic check result due to the operating status of each application. After an abnormality diagnosis, a signal for illuminating the warning lamp can be prepared in accordance with the result of diagnosis and transmitted to the warning lamp through the input/output unit 107 for the purpose of issuing an illumination command to the warning lamp, or the diagnostic check result can be stored in the log storage section and used to investigate the cause of abnormality.

What is claimed is:

1. An automotive control unit for use in a vehicle-mounted system in which a plurality of automotive control units are connected through a communication bus to communicate data with each other, the automotive control unit comprising:
an arithmetic processing unit for performing arithmetic processing in order to control a vehicle-mounted device; and
a storage unit for storing a program to be processed by the arithmetic processing unit, the program including a plurality of applications for controlling the vehicle-mounted device and a common execution environment section for permitting the applications to exchange data with each other;
wherein the program includes a communication protection section that, when the applications exchange data with the common execution environment section, checks the data for an abnormality, and a system abnormality check section that determines in accordance with an abnormality check result produced by the communication protection section whether the system is abnormal, and the program executes at least one of processes of outputting a log, storing a log in the storage unit, and controlling the vehicle-mounted device in accordance with a check result produced by the system abnormality check section.

2. The automotive control unit according to claim 1, wherein the system abnormality check section includes application operating status management section for acquiring the operating status of the applications, check rule decision section for changing a system abnormality check rule in accordance with the operating status, and status determination section for checking for a system abnormality in accordance with the system abnormality check rule selected by the check rule decision section.

3. The automotive control unit according to claim 2, wherein the operating status includes a halt state of the applications.

4. The automotive control unit according to claim 2, wherein the communication protection section uses at least either an error detection code or a message counter.

5. The automotive control unit according to claim 2, wherein the data to be checked for an abnormality by the communication protection section is received from a remote one of the automotive control units through the communication bus.

6. An automotive control system comprising:
a plurality of automotive control units; and
a communication bus for permitting the automotive control units to communicate data with each other,
the automotive control units each including an arithmetic processing unit for performing arithmetic processing in order to control a vehicle-mounted device, and a storage unit for storing a program to be processed by the arithmetic processing unit, the program including a plurality of applications for controlling the vehicle-mounted device and a common execution environment section for permitting the applications to exchange data with each other,
wherein the program includes a communication protection section that, when the applications exchange data with the common execution environment section, checks the data for an abnormality, and a system abnormality check section that determines in accordance with an abnormality check result produced by the communication protection section whether the system is abnormal; and
wherein the system abnormality check section includes application operating status management section for acquiring the operating status of the applications, check rule decision section for changing a system abnormality check rule in accordance with the operating status, and status determination section for checking for a system abnormality in accordance with the system abnormality check rule selected by the check rule decision section.
